(19) United States
(12) Patent Application Publication
(10) Pub. No.: US 2026/0249336 A1
(43) Pub. Date: Aug. 27, 2026

(54) ELECTRODE SHEET ROLL-PRESSING AND CUTTING SYSTEM AND METHOD

(71) Applicant: CONTEMPORARY AMPEREX TECHNOLOGY CO., LIMITED, Ningde (CN)

(72) Inventors: Chunxu WU, Ningde (CN); Ping JIANG, Ningde (CN); Zhipeng ZHANG, Ningde (CN); Hongyuan LI, Ningde (CN)

(73) Assignee: CONTEMPORARY AMPEREX TECHNOLOGY CO., LIMITED, Ningde (CN)

(21) Appl. No.: 19/651,425

(22) Filed: Apr. 17, 2026

Related U.S. Application Data
(63) Continuation of application No. PCT/CN2024/099132, filed on Jun. 14, 2024.

(30) Foreign Application Priority Data
Feb. 22, 2024 (CN) 202410199207.X

(51) Int. Cl. B21B 15/00; H01M 4/04

(52) U.S. Cl. CPC B21B 15/0007; H01M 4/0435

(57) ABSTRACT

An electrode sheet roll-pressing and cutting system are disclosed. The system includes: an encoder, a detection mechanism, a programmable logic controller and a marking mechanism. The detection mechanism shoots images of an electrode sheet in the system based on a frequency of a pulse signal output by the encoder. An upper computer determines a defect region of the electrode sheet based on an N(th) image of the electrode sheet shot by the detection mechanism and, based on the defect region, determines the number S of pulses that the programmable logic controller needs to await. When determining that the S pulses have been awaited, the programmable logic controller sends a marking instruction to the marking mechanism. The marking mechanism marks the defect region of the electrode sheet. The upper computer is configured to identify edges of a tab region image and determine the size of the tab region based on the edges.

### CROSS-REFERENCE TO RELATED APPLICATIONS

This application is a continuation of International application PCT/CN2024/099132 filed on Jun. 14, 2024 that claims priority to Chinese Patent Application No. 202410199207.X, filed on Feb. 22, 2024. The content of these applications is incorporated herein by reference in its entirety.

### TECHNICAL FIELD

The present application relates to the technical field of batteries, and in particular, to an electrode sheet roll-pressing and cutting system and method.

### BACKGROUND

A battery electrode sheet is an important component of a battery cell. The battery electrode sheet is usually manufactured by roll-pressing and cutting a plate material. In order to improve the manufacturing efficiency, in the related art, a roll-pressing and cutting system is mainly used for processing and manufacturing the battery electrode sheet.

In a manufacturing process of the battery electrode sheet, in order to improve the quality of the electrode sheet produced by a roll-pressing and cutting process and improve the safety and capacity consistency of the battery cell, it is necessary to accurately detect surface defects of a roll-pressed and cut electrode sheet. In view of this, it is necessary to provide a solution for detecting the surface defects of the roll-pressed and cut electrode sheet.

### SUMMARY

Embodiments of the present application provide an electrode sheet roll-pressing and cutting system and method. Through the system and the method, defects on a surface of an electrode sheet can be detected, and a defect region can be accurately marked.

According to a first aspect, the present application provides an electrode sheet roll-pressing and cutting system, and the system includes:
an encoder, configured to output a pulse signal to a detection mechanism and a programmable logic controller respectively when an electrode sheet in the system is conveyed in a first direction;
the detection mechanism, configured to shoot an image of the electrode sheet based on the frequency of the pulse signal;
an upper computer, configured to determine a defect region of the electrode sheet based on an N(th) image of the electrode sheet shot by the detection mechanism, where N is a natural number; and further configured to: determine a response distance of a marking mechanism based on a position of the defect region in a target electrode sheet region, where the target electrode sheet region is an electrode sheet region shot in the N(th) image; determine the number S of pulses that the programmable logic controller needs to await based on the response distance and accuracy of the encoder; and send the number S of pulses to the programmable logic controller, where S is a natural number;
the programmable logic controller, when determining that the S pulses have been awaited, configured to send a marking instruction to the marking mechanism;
the marking mechanism, configured to mark the defect region of the electrode sheet based on the marking instruction; and
the image shot by the detection mechanism including a tab region image corresponding to a tab region; and
the upper computer, being further configured to identify edges of the tab region image and determine the size of the tab region based on the edges.

Thus, the present application can determine the defect region in the electrode sheet, and accurately mark the defect region based on the position of the defect region in the electrode sheet. In addition, the size information of the tab region in the electrode sheet can also be obtained through the upper computer.

As a possible implementation, the marking mechanism is located downstream of the detection mechanism, a first distance between the detection mechanism and the marking mechanism is a sum of the sizes of (M+1) images and a redundant distance, and the size of a single image is a length of an electrode sheet region shot in the image in the first direction, where M is a natural number;
the upper computer is configured to determine a second distance between the defect region and a target edge of the target electrode sheet region, the target edge being an edge of the target electrode sheet region in an electrode sheet transmission direction; and determine a sum of the second distance and the redundant distance as a response distance of the marking mechanism;
when determining that the detection mechanism has shot the (N+M)th image of the electrode sheet, the upper computer is further configured to send the number S of pulses to the programmable logic controller.

Thus, the marking mechanism can be accurately controlled to mark the defect position of the electrode sheet.

As a possible implementation, the electrode sheet roll-pressing and cutting system further includes a cutting mechanism;
the cutting mechanism is configured to cut a first electrode sheet input into the system into a plurality of second electrode sheets, where a width of the first electrode sheet is greater than a width of the second electrode sheet;
the detection mechanism includes a first detection mechanism disposed upstream of the cutting mechanism and a plurality of second detection mechanisms disposed downstream of the cutting mechanism, and the plurality of second detection mechanisms are in one-to-one correspondence with the plurality of second electrode sheets;
the first detection mechanism is configured to shoot a first surface of the first electrode sheet based on the frequency of the pulse signal to obtain a first image;
the plurality of second detection mechanisms are configured to shoot second surfaces of the plurality of second electrode sheets based on the frequency of the pulse signal to obtain a plurality of second images; and
the upper computer is configured to determine the sizes of the defect region and the tab region of the first electrode sheet and/or the plurality of second electrode sheets based on the first image and/or the plurality of second images.

Thus, with the provision of the first detection mechanism and the plurality of second detection mechanisms, defects on the first surface and second surface of each electrode sheet in the electrode sheet roll-pressing and cutting system can be detected and the size of the tab region of each electrode sheet can be determined.

As a possible implementation, the upper computer is configured to generate edge points at the edges; remove discrete edge points from the edge points to obtain target edge points; perform straight line fitting on the target edge points to obtain two edge lines in a second direction, the second direction being perpendicular to the first direction; and determine a distance between the two edge lines as the size of the tab region.

Thus, the size of the tab region in the second direction can be obtained.

As a possible implementation, the electrode sheet roll-pressing and cutting system further includes a deviation correction mechanism;
the upper computer is further configured to determine a deviation correction value according to the sizes of the plurality of tab regions determined from the plurality of second images, and send the deviation correction value to the deviation correction mechanism; and
the deviation correction mechanism is configured to perform deviation correction on the electrode sheet based on the deviation correction value.

Thus, the deviation correction of the electrode sheet roll-pressing and cutting system can be realized, and the product quality of the electrode sheet roll-pressing and cutting system can be improved.

As a possible implementation, the upper computer is configured to determine a size difference between each pair of tab regions in the plurality of tab regions, and each pair of tab regions is two tab regions located on two sides of a same cutting position; and determine the deviation correction value based on the size difference.

Thus, the deviation correction value that can represent the dimensional consistency of the tab region of the second electrode sheet can be obtained.

As a possible implementation, the upper computer is configured to extract a target image region corresponding to a target detection region of the electrode sheet from the N(th) image of the electrode sheet; perform binarization on the target image region to obtain a binary image of the target detection region; screen out a target region having an area greater than or equal to an area threshold and a width greater than or equal to a width threshold from a foreground image of the binary image; and determine the target region as the defect region of the electrode sheet.

Thus, the defect region that is located in the target detection region and affects the performance of the electrode sheet can be accurately detected.

As a possible implementation, the first detection mechanism further includes a first camera, a first light source, and a first detection roller;
the first camera is disposed toward the first detection roller;
the first detection roller is configured to support the first electrode sheet, so that a first surface of the first electrode sheet faces the first camera;
the first light source is configured to illuminate the first surface; and
the first camera is configured to shoot the illuminated first surface based on the frequency of the pulse signal to obtain the first image.

Thus, with the provision of the first light source and the first detection roller, the first detection mechanism can more conveniently shoot the first surface of the first electrode sheet, and the defects on the first surface of the first electrode sheet can be made more prominent in the first image.

As a possible implementation, the second detection mechanism includes a second camera, a second light source, and a second detection roller;
the second camera is disposed toward the second detection roller;
the second detection roller is configured to support the second electrode sheet, so that a second surface of the second electrode sheet faces the second camera;
the second light source is configured to illuminate the second surface; and
the second camera is configured to shoot the illuminated second surface based on the frequency of the pulse signal to obtain the second image.

Thus, with the provision of the second light source and the second detection roller, the second detection mechanism can more conveniently shoot the second surface of the second electrode sheet, and the defects on the second surface of the second electrode sheet can be made more prominent in the second image.

According to a second aspect, the present application provides an electrode sheet roll-pressing and cutting method, and the method includes:
outputting, by an encoder, a pulse signal to a detection mechanism and a programmable logic controller respectively when an electrode sheet in an electrode sheet roll-pressing and cutting system is conveyed in a first direction;
shooting, by the detection mechanism, an image of the electrode sheet based on a frequency of the pulse signal;
determining, by an upper computer, a defect region of the electrode sheet based on an N(th) image of the electrode sheet shot by the detection mechanism, where N is a natural number;
determining, by the upper computer, a response distance of a marking mechanism based on a position of the defect region in a target electrode sheet region, where the target electrode sheet region is an electrode sheet region shot in the N(th) image;
determining, by the upper computer, the number S of pulses that the programmable logic controller needs to await based on the response distance and accuracy of the encoder, where S is a natural number;
sending the number S of pulses to the programmable logic controller by the upper computer;
sending, by the programmable logic controller, when determining that the S pulses have been awaited, a marking instruction to the marking mechanism; and
marking, by the marking mechanism, the defect region of the electrode sheet based on the marking instruction;
the image shot by the detection mechanism including a tab region image corresponding to a tab region; and the electrode sheet roll-pressing and cutting method further includes:
by the upper computer, identifying edges of the tab region image and determining the size of the tab region based on the edges.

Thus, the present application can determine the defect region in the electrode sheet, and accurately mark the defect region based on the position of the defect region in the electrode sheet. In addition, the size information of the tab region in the electrode sheet can also be obtained through the upper computer.

As a possible implementation, the marking mechanism is located downstream of the detection mechanism, a first distance between the detection mechanism and the marking mechanism is a sum of the sizes of (M+1) images and a redundant distance, and the size of a single image is a length of an electrode sheet region shot in the image in the first direction, where M is a natural number;
the determining, by the upper computer, a response distance of a marking mechanism based on a position of the defect region in a target electrode sheet region includes:
determining, by the upper computer, a second distance between the defect region and a target edge of the target electrode sheet region, the target edge being an edge of the target electrode sheet region in an electrode sheet transmission direction; and
determining a sum of the second distance and the redundant distance as a response distance of the marking mechanism; and
the sending the number S of pulses to the programmable logic controller by the upper computer includes:
sending, by the upper computer, when determining that the detection mechanism has shot the (N+M)th image of the electrode sheet, the number S of pulses to the programmable logic controller.

Thus, the defect position of the electrode sheet can be accurately marked.

As a possible implementation, the electrode sheet in the electrode sheet roll-pressing and cutting system includes a first electrode sheet input into the system and a plurality of second electrode sheets obtained by cutting the first electrode sheet by a cutting mechanism, the detection mechanism comprises a first detection mechanism and a plurality of second detection mechanisms, and the plurality of second detection mechanisms are in one-to-one correspondence with the plurality of second electrode sheets; and the shooting, by the detection mechanism, an image of the electrode sheet based on a frequency of the pulse signal includes:
shooting, by the first detection mechanism, a first surface of the first electrode sheet based on the frequency of the pulse signal to obtain a first image; and
shooting, by the plurality of second detection mechanisms, second surfaces of the plurality of second electrode sheets based on the frequency of the pulse signal to obtain a plurality of second images.

Thus, with the provision of the first detection mechanism and the plurality of second detection mechanisms, defects on the first surface and second surface of each electrode sheet in the electrode sheet roll-pressing and cutting system can be detected.

### BRIEF DESCRIPTION OF THE DRAWINGS

The feature, advantage, and technical effect of the exemplary embodiment of the present application is described below with reference to the figures.

FIG. 1 is a schematic diagram of an electrode sheet roll-pressing and cutting system according to an embodiment of the present application;

FIG. 2 is a schematic diagram of marking logic modeling of a marking mechanism according to an embodiment of the present application;

FIG. 3 is a schematic diagram of a provision position of a detection mechanism according to an embodiment of the present application;

FIG. 4 is a schematic diagram of determining size information of a tab region according to an embodiment of the present application;

FIG. 5 is a schematic diagram of an electrode sheet roll-pressing and cutting system according to an embodiment of the present application;

FIG. 6 is a schematic diagram of a first electrode sheet according to an embodiment of the present application;

FIG. 7 is a schematic diagram of a second electrode sheet according to an embodiment of the present application;

FIG. 8 is a flowchart of determining a defect region of an electrode sheet according to an embodiment of the present application;

FIG. 9 is a schematic diagram of a detection mechanism according to an embodiment of the present application;

FIG. 10 is a schematic diagram of an installation position of a camera in a detection mechanism according to an embodiment of the present application;

FIG. 11 is a schematic diagram of a first detection mechanism according to an embodiment of the present application;

FIG. 12 is a schematic diagram of a second detection mechanism according to an embodiment of the present application;

FIG. 13 is a schematic diagram of an image of an anode electrode sheet according to an embodiment of the present application;

FIG. 14 is a schematic diagram of an image of a cathode electrode sheet according to an embodiment of the present application; and

FIG. 15 is a flowchart of an electrode sheet roll-pressing and cutting method according to an embodiment of the present application.

The figures are not necessarily drawn to the actual scale.

### DETAILED DESCRIPTION

To make the objectives, technical solutions, and advantages of the embodiments of the present application clearer, the following clearly and completely describes the technical solutions in the embodiments of the present application with reference to the accompanying drawings in the embodiments of the present application. Apparently, the described embodiments are some but not all of the embodiments of the present application. All other embodiments obtained by a person of ordinary skill in the art based on the embodiments of the present application without making creative efforts shall fall within the protection scope of the present application.

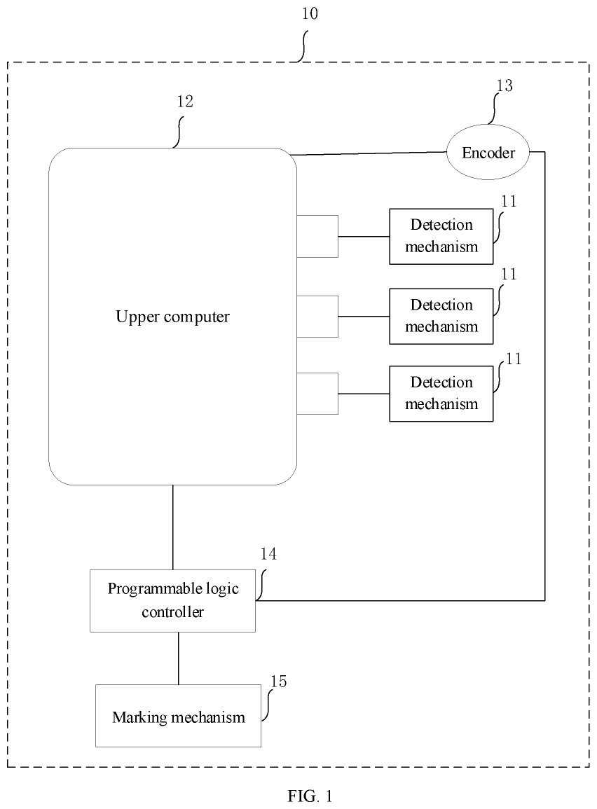

FIG. 1 is a schematic diagram of an electrode sheet roll-pressing and cutting system according to an embodiment of the present application. As shown in FIG. 1, the system 10 may include: a detection mechanism 11, an upper computer 12, an encoder 13, a programmable logic controller 14 and a marking mechanism 15, where the upper computer 12 is connected to the detection mechanism 11 and the programmable logic controller 14 respectively, the encoder 13 is connected to the detection mechanism 11 and the programmable logic controller 14 respectively, and the marking mechanism 15 is connected to the programmable logic controller 14.

In some embodiments of the present application, the system 10 may include one or more detection mechanisms 11, and each detection mechanism 11 is connected to the upper computer 12. FIG. 1 takes the system 10 including three detection mechanisms 11 as an example, and the three detection mechanisms 11 are respectively connected to the upper computer 12. It should be noted that the number of detection mechanisms 11 included in the system 10 may be set according to the number of electrode sheets that need to be detected in the system 10, and the three detection mechanisms 11 are only examples, and do not constitute a specific limitation on the number of detection mechanisms 11 in the system 10.

The encoder 13 is configured to output a pulse signal to a detection mechanism 11 and a programmable logic controller 14 respectively when an electrode sheet in the system 10 is conveyed in a first direction, where the first direction is a conveying direction of the electrode sheet in the system 10. The frequency of the pulse signal output by the encoder 13 is determined based on the conveying speed of the electrode sheet in the system 10.

In some embodiments of the present application, the system 10 further includes a conveying roller for conveying the electrode sheet, the encoder 13 may be coaxially connected to the conveying roller, and output a pulse signal as the conveying roller rotates, so that the encoder 13 may synchronously output the pulse signal when the electrode sheet is conveyed by the conveying roller. Thus, the shooting frequency of the detection mechanism 11 when shooting the electrode sheet based on the pulse signal is consistent with the conveying speed of the electrode sheet, so that the detection mechanism 11 can shoot a complete image of each electrode sheet region in the electrode sheet.

In the case where the system 10 includes a plurality of detection mechanisms 11, the encoder 13 may synchronously output the pulse signal to a plurality of detection mechanisms 11 when the electrode sheet is conveyed by the system 10, so that the plurality of detection mechanisms 11 synchronously shoot images.

The detection mechanism 11 is configured to shoot an image of the electrode sheet in the system 10 based on the frequency of the pulse signal.

The upper computer 12 is configured to determine a defect region of the electrode sheet based on an N(th) image of the electrode sheet shot by the detection mechanism 11, where Nis a natural number.

In some embodiments of the present application, N may be a value greater than or equal to 1, the N(th) image of the electrode sheet may be used to indicate the latest image of the electrode sheet received by the upper computer 12 during the operation of the system 10, and the value of N may change with the operation of the system 10. After obtaining the N(th) image of the electrode sheet, the upper computer 12 may detect the N(th) image based on a preset defect detection algorithm in the upper computer 12, thereby determining the defect region in the electrode sheet. The defect region in the electrode sheet may be a region with defects on the surface of the electrode sheet, and the surface defects may include, but are not limited to, defects such as foil leakage, decarburization, white spots, and bubbles on the surface.

The upper computer 12 is further configured to determine a response distance of a marking mechanism 15 based on a position of the defect region in a target electrode sheet region after determining the defect region of the electrode sheet based on the N(th) image, where the target electrode sheet region is an electrode sheet region shot in the N(th) image; determine the number S of pulses that the programmable logic controller 14 needs to await based on the response distance and accuracy of the encoder 13; and send the number S of pulses to the programmable logic controller 14, where S is a natural number.

In this embodiment, the accuracy of the encoder 13 is used to indicate a moving distance of an electrode sheet corresponding to one pulse output by the encoder 13 in the first direction. Based on this, when the number S of pulses that the programmable logic controller 14 needs to await is determined based on the response distance and the accuracy of the encoder 13, the ratio of the response distance to the encoder 13 may be used as the number S of pulses.

In some embodiments of the present application, the accuracy of the encoder 13 may be determined according to a circumference of the conveying roller connected to the encoder 13 and the number of pulses output by the encoder 13 per rotation of the conveying roller, and a ratio of the circumference of the conveying roller to the number of pulses output by the encoder 13 per rotation of the conveying roller is used as the accuracy of the encoder 13, where a diameter of the conveying roller is a determined size, so the circumference is also a fixed value; and once the encoder 13 is selected, the number of pulses output by the encoder 13 per rotation of the conveying roller is also determined, and thus it can be learned that after the encoder 13 is determined, the accuracy of the encoder 13 is fixed and does not change with a rotation speed of the conveying roller, that is, a conveying speed of the electrode sheet. Based on this, after the encoder 13 is determined, the accuracy of the encoder 13 may be stored in the upper computer 12, so that the upper computer 12 may directly obtain the accuracy of the encoder 13 when determining the number S of pulses. In this embodiment, the response distance of the marking mechanism 15 refers to a distance between the defect region and the marking mechanism 15 when the upper computer 12 sends the number S of pulses to the programmable logic controller 14, and the response distance can be accurately determined based on the position of the defect region on the target electrode sheet region.

The programmable logic controller 14 is configured to send a marking instruction to the marking mechanism 15 when determining that the S pulses have been awaited.

In this embodiment, the marking mechanism 15 is controlled to mark by the programmable logic controller 14, and the programmable logic controller 14 may count the number of received pulses after receiving the number S of pulses sent by the upper computer 12, and determine that the defect region reaches the position of the marking mechanism 15 when determining that S pulses are received, thereby outputting a marking instruction for instructing the marking mechanism 15 to mark to the marking mechanism 15.

The marking mechanism 15 is configured to mark the defect region of the electrode sheet based on the marking instruction.

In this embodiment, after receiving the marking instruction output by the programmable logic controller 14, the marking mechanism 15 marks the electrode sheet in response to the marking instruction.

In an existing control method of the marking mechanism 15, the upper computer 12 usually outputs a hardware frame signal to the marking mechanism 15 through a hardware circuit such as an acquisition card, so as to control the marking mechanism 15 to mark. However, for this method, the hardware circuit supporting the output of the hardware frame signal needs to be provided. This makes the system more complex and difficult to implement. Moreover, the hardware frame signal has poor stability, resulting in inaccurate marking. However, in this embodiment, the programmable logic controller 14 is used to control the marking mechanism 15 to mark by pulse signal counting, and the upper computer 12 is not required to output the hardware frame signal to the marking mechanism 15, so the hardware circuit does not need to be provided, which effectively reduces the system complexity. The system is easier to implement, and the pulse signal is more stable, thus the marking mechanism 15 can accurately mark the defect position of the electrode sheet. In some embodiments, the marking mechanism 15 is located downstream of the detection mechanism 11, and a first distance between the detection mechanism 11 and the marking mechanism 15 is set to a sum of the sizes of the (M+1) images and a redundant distance, and the size of a single image is a length of an electrode sheet region shot in the image in the first direction.

In some embodiments of the present application, it takes a certain time for the upper computer 12 to determine the defect region of the electrode sheet based on the image, and during the detection of the defect region, the system 10 still continues to transport the electrode sheet to the marking mechanism 15 in the first direction. Therefore, in order to avoid that the marking mechanism 15 cannot mark the defect region due to an untimely response, the sum of the sizes of the (M+1) images and the redundant distance may be used as the first distance.

The first distance between the detection mechanism 11 and the marking mechanism 15 may be set according to the following formula (1):

$${L}_{1} = ( M + 1 ) * {L}_{0} + {L}_{3} \qquad ( 1 )$$

in the formula (1), L₁ represents the first distance, L₀ represents the size of the single image shot by the detection mechanism 11, and L₃ represents the redundant distance. M may be a preset natural number greater than or equal to 1, and the redundancy distance may be set according to an actual situation.

The reason for setting the redundant distance is that it takes a certain time from the programmable logic controller 14 outputting the marking instruction to the marking mechanism 15 making a standard response based on the marking instruction, and during this period, the electrode sheet is still moving toward the marking mechanism 15. Therefore, in order to enable the marking mechanism 15 to accurately mark at the defect position, the redundant distance is set. The redundant distance may be determined according to the time required from the output of the marking instruction by the programmable logic controller 14 to the marking response made by the marking mechanism 15 based on the marking instruction, and the conveying speed of the electrode sheet.

In some embodiments of the present application, the sum of the transmission time of the marking instruction and the response time of the marking mechanism 15 may be used as the time required from the output of the marking instruction by the programmable logic controller 14 to the marking response made by the marking mechanism 15 based on the marking instruction, and the product of the time and the highest conveying speed of the electrode sheet in the system 10 may be used as the redundant distance. The transmission time of the marking instruction refers to the time required for transmitting the marking instruction from the programmable logic controller 14 to the marking mechanism 15, and the response time of the marking mechanism 15 refers to the time from the marking instruction being received by the marking mechanism 15 to the marking response being made by the marking mechanism.

The redundant distance may be calculated according to the following formula (2):

$${L}_{3} = ( {T}_{0} + {T}_{1} ) * {V}_{max} ; \qquad ( 2 )$$

in the formula (2), T₀ represents a response time of the marking mechanism 15; T₁ represents a transmission time of the marking instruction; and Vₘₐₓ represents a highest conveying speed of the electrode sheet in the system 10.

In some embodiments of the present application, in order to make the first distance between the marking mechanism 15 and the detection mechanism 11 more reasonable, the first distance is neither too long to waste design space nor too short to make the marking mechanism 15 not respond in time, and the value of M may be set to 1. Based on this, the first distance may be the sum of the sizes of the two images and the redundant distance, and may be calculated according to the following formula (3):

$${L}_{1} = 2 * {L}_{0} + {L}_{3} . \qquad ( 3 )$$

In addition, in some embodiments of the present application, in order to prevent the distance reserved between the detection mechanism 11 and the marking mechanism 15 from being too extreme, the actual redundant distance may be set as the theoretically calculated redundant distance plus 20% of the theoretical value.

Based on the above design, the upper computer 12 may determine the response distance of the marking mechanism 15 in the following manner:
determining a second distance between the defect region and a second edge of the target electrode sheet region, the target electrode sheet region including a first edge and the second edge, and a direction from the first edge to the second edge being the first direction; and determining a sum of the second distance and the redundant distance as a response distance of the marking mechanism 15.

Correspondingly, when determining that the detection mechanism 11 has shot the (N+M)th image of the electrode sheet, the upper computer 12 may immediately send the number S of pulses to the programmable logic controller 14.

In this embodiment, because the position of the detection mechanism 11 remains unchanged when the detection mechanism 11 shoots the electrode sheet, the system 10 conveys the electrode sheet to the marking mechanism 15 in the first direction, the size of the single image shot by the detection mechanism 11 may be understood as a distance by which the electrode sheet moves to the marking mechanism 15 when the detection mechanism 11 shoots the image. Based on this, the sizes of the (M+1) images may be understood as a total distance by which the electrode sheet moves toward the marking mechanism 15 in a period from a time when the detection mechanism 11 starts to shoot the N(th) image of the electrode sheet to a time when the (N+M)th image of the electrode sheet is shot. The first distance between the detection mechanism 11 and the marking mechanism 15 is the sum of the sizes of the (M+1) images and the redundant distance. Therefore, when the detection mechanism 11 completes shooting of the (N+M)th image of the electrode sheet, only the redundant distance remains between the second edge of the target electrode sheet region corresponding to the (N)th image and the marking mechanism 15. In consideration of the defect region being not necessarily located at the second edge of the target electrode sheet region, in order to enable the marking mechanism 15 to accurately mark the defect region of the electrode sheet, the first distance between the defect region and the second edge of the target electrode sheet region is further determined, and the sum of the first distance and the redundant distance is used as the response distance of the marking mechanism 15. After the response distance is obtained, the number S of pulses that need to await from the time when the detection mechanism completes shooting of the (N+M)th image of the electrode sheet to the time when the defect region is moved to the position of the marking mechanism 15 is determined according to the response distance and the accuracy of the encoder 13. The number S of pulses is transmitted to the programmable logic controller 14 as marking information. The precision of the encoder 13 is used to indicate a distance value corresponding to each pulse output by the encoder 13.

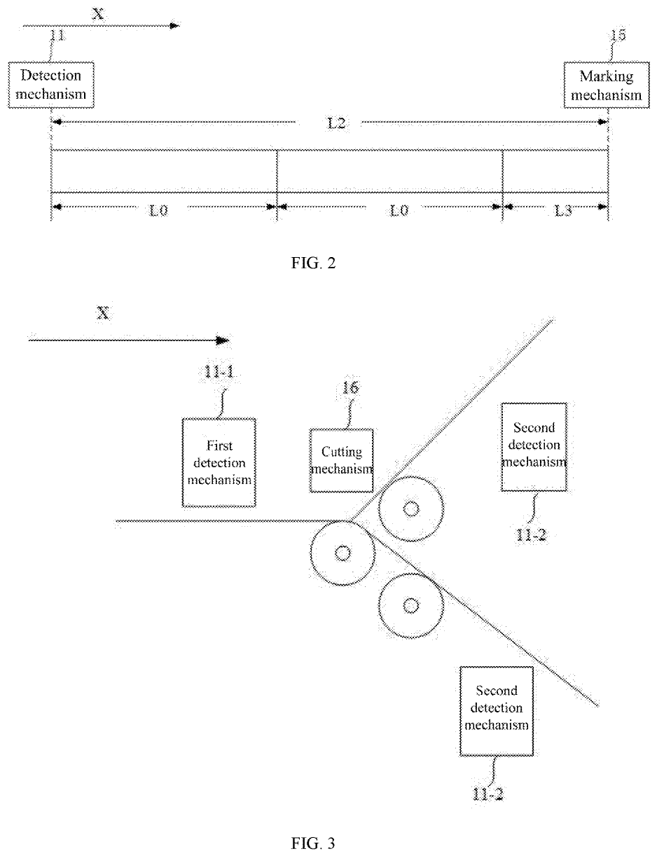

In some specific embodiments, for example, M is taken as 1. As shown in FIG. 2, a marking logic may be modeled, including the detection mechanism 11, the marking mechanism 15, the size of the (N)th image, and the size of the (N+1)th image of the electrode sheet shot by the detection mechanism 11. In this embodiment, the size of each image is consistent, and is L₀. The second distance is determined based on the position of the defect region in the target electrode sheet region as L₂. The conveying direction of the electrode sheet is the first direction X, and the first distance between the detection mechanism 11 and the marking mechanism 15 is L₁. The redundancy distance is L₃. The accuracy of the encoder 13 is P₀. The highest conveying speed of the electrode sheet in the system 10 is max. The response time of the marking mechanism 15 is T₀. The transmission time of the marking instruction is T₁, where L₀|, L₁, L₂, L₃ and P₀ have a same unit in millimeters. T₀ and T₁ have a same time unit in seconds, and Vₘₐₓ may have a unit in mm/s. Based on this, the upper computer 12 may take the sum of the size of the (N)th image and the size of the (N+1)th image as 2*L₀ the total distance of the electrode sheet moving toward the marking mechanism 15 during the period from when the detection mechanism 11 starts to shoot the (N)th image of the electrode sheet to the end of shooting the (N+1)th image of the electrode sheet. The redundant distance is obtained by subtracting the total distance 2*L₀ of the electrode sheet moving toward the marking mechanism 15 from the first distance L₁. The sum of the second distance L₂ and the redundant distance L₃ is taken as the response distance of the marking mechanism 15, and the ratio of the response distance to the precision of the encoder 13 is determined as the number S of pulses.

The number S of pulses may be determined according to the following formula (4):

$$S = ( {L}_{1} - 2 * {L}_{0} + {L}_{2} ) / {P}_{0} . \qquad ( 4 )$$

In the above manner, the marking mechanism 15 can be precisely controlled, so that the marking mechanism 15 can accurately mark the defect region in the electrode sheet.

Further, the image shot by the detection mechanism 11 includes a tab region image corresponding to the tab region.

Based on this, the upper computer 12 is further configured to identify edges of the tab region image and determine the size of the tab region based on the edges.

In addition, the size of the tab region in the electrode sheet can be obtained by the upper computer 12.

In some embodiments, the image shot by the detection mechanism 11 may be a color image or a grayscale image, and when the image is the grayscale image, the upper computer 12 may directly identify the edge of the tab region image in the image based on a grayscale value. When the image is the color image, the upper computer 12 may convert the image into the grayscale image, and then identify the edge of the tab region image in the converted image based on the grayscale value.

In some embodiments of the present application, the electrode sheet may include a plurality of regions. For example, when the electrode sheet is an anode electrode sheet, the electrode sheet may include a tab region and a coating region; and when the electrode sheet is a cathode electrode sheet, the electrode sheet may include the tab region, the coating region and an anti-tearing region (also referred to as an AT region). Grayscale value ranges of the image regions corresponding to different regions in the image shot by the detection mechanism 11 are different, and based on this, the upper computer 12 can determine the edge of the tab region image in the image through Blob analysis, and Blob refers to a connected region in the image. Blob analysis is a commonly used analysis tool in image processing, widely applied in object detection, recognition, and tracking. The essence of Blob analysis is to group pixels with the same grayscale value range into a same detection object based on different neighborhood types. Thus, positions with significant grayscale changes can be determined and are the edges of the region image. Based on this, the edge of the tab region image may be determined based on the grayscale value range corresponding to the tab region.

After identifying the edge of the tab region image, the upper computer 12 may determine the size of the tab region based on the edge in the following manner:
generating first edge points at the edges; removing discrete edge points from the first edge points to obtain second edge points; performing straight line fitting on the second edge points to obtain two edge lines in a second direction, the second direction being perpendicular to the first direction; and determining a distance between the two edge lines as the size of the tab region.

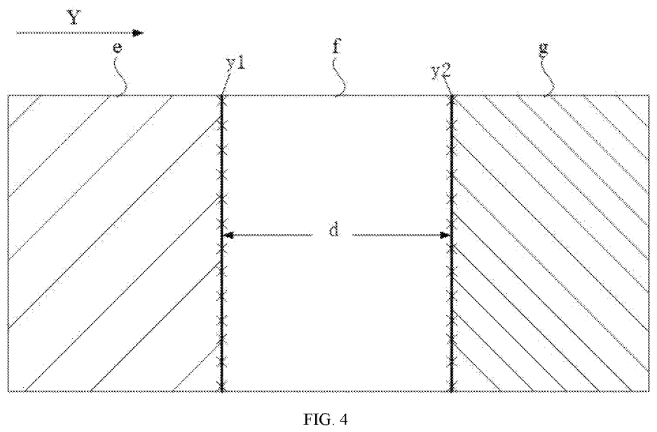

In some embodiments of the present application, for example, the electrode sheet is taken as the anode electrode sheet, a partial region of the image shot by the detection mechanism 11 is shown in FIG. 4, where e represents an image region corresponding to other mechanisms other than the electrode sheet, for example, an image region corresponding to a detection roller for supporting the electrode sheet; f represents an image region corresponding to a tab region in the electrode sheet, namely, a tab region image; and g represents an image region corresponding to a coating region in the electrode sheet. The upper computer 12 may generate a fork edge point at the edge of the tab region image f by using a caliper tool, then screen out discrete abnormal edge points, and use the remaining edge points to fit two edge lines y1 and y2 in the second direction Y by a straight line. The size of the tab region is obtained by calculating the distance d between midpoints of the two edge lines.

Thus, the size of the tab region in the second direction can be obtained.

In some embodiments, the system 10 further includes a cutting mechanism 16.

The cutting mechanism 16 is configured to cut a first electrode sheet input into the system 10 into a plurality of second electrode sheets, where a width of the first electrode sheet is greater than a width of the second electrode sheet.

Based on this, the electrode sheet in the system 10 may include the first electrode sheet before being cut and the plurality of second electrode sheets obtained by cutting the first electrode sheet by the cutting mechanism 16. The first electrode sheet is an electrode sheet input into the system 10, and is usually an electrode sheet after being rolled, the second electrode sheet is an electrode sheet that needs to be output by the system 10, and the second electrode sheet may be wound by a winding mechanism after being output from the system 10. The first electrode sheet includes a first surface and a second surface in a thickness direction, and because the second electrode sheet is obtained by cutting the first electrode sheet, the second electrode sheet also includes a first surface and a second surface in a thickness direction, the first surfaces of the plurality of second electrode sheets may jointly form the first surface of the first electrode sheet, and the second surfaces of the plurality of second electrode sheets may jointly form the second surface of the first electrode sheet.

In order to avoid missing detection of the electrode sheet in the system 10, the detection mechanism 11 included in the system 10 may include a first detection mechanism disposed upstream of the cutting mechanism 16 and a plurality of second detection mechanisms disposed downstream of the cutting mechanism 16, and the plurality of second detection mechanisms are in one-to-one correspondence with the plurality of second electrode sheets, that is, one second detection mechanism is correspondingly disposed for each second electrode sheet obtained by cutting in the system 10.

The first detection mechanism is configured to shoot a first surface of the first electrode sheet based on the frequency of the pulse signal to obtain a first image.

The plurality of second detection mechanisms are configured to shoot second surfaces of the plurality of second electrode sheets based on the frequency of the pulse signal to obtain a plurality of second images; and
the upper computer 12 is configured to determine the sizes of the defect region and the tab region of the first electrode sheet and/or the plurality of second electrode sheets based on the first image and/or the plurality of second images.

In some embodiments, the cutting mechanism 16 can cut the first electrode sheet into two second electrode sheets, and based on this, as shown in FIG. 3, the system 10 can include three detection points, where a detection point A is located upstream of the cutting mechanism 16, detection points B and C are located downstream of the cutting mechanism 16, a first detection mechanism 11-1 is provided at the detection point A, and a second detection mechanism 11-2 is provided at each of the detection points B and C. Thus, the first detection mechanism 11-1 disposed at the detection point A can shoot an image of the first surface of the first electrode sheet, the second detection mechanism 11-2 disposed at the detection point B can shoot an image of a second surface of one second electrode sheet obtained by cutting, and the second detection mechanism 11-2 disposed at the detection point C can shoot an image of a second surface of the other second electrode sheet obtained by cutting.

Since the plurality of second electrode sheets are obtained by cutting the first electrode sheet, the first image includes images of the first surfaces of the plurality of second electrode sheets, and similarly, the plurality of second images may constitute a complete image of the second surface of the first electrode sheet. Thus, the first detection mechanism 11-1 and the plurality of second detection mechanisms 11-2 are provided, so that the defects on the first surface and second surface of each electrode sheet in the electrode sheet roll-pressing and cutting system 10 can be detected and the size of the tab region of each electrode sheet can be determined.

In some embodiments, the system 10 may further include a deviation correction mechanism 17.

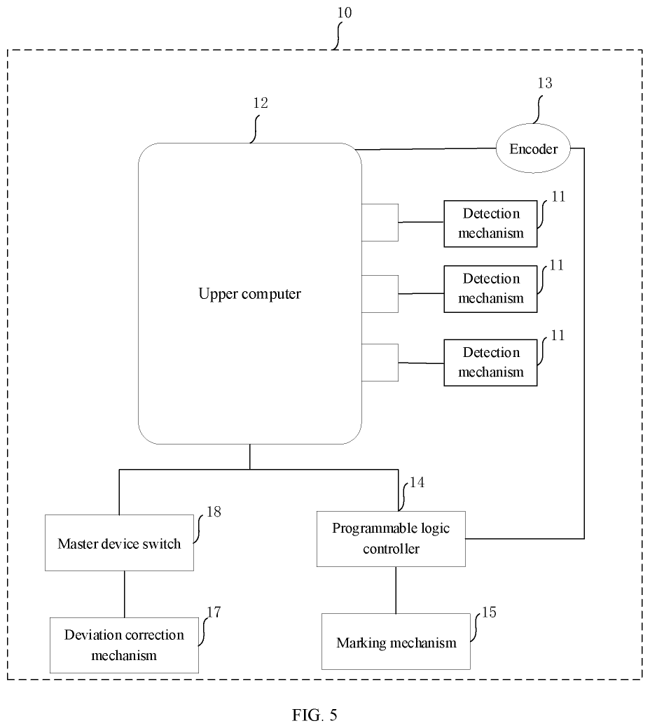

As shown in FIG. 5, the deviation correction mechanism 17 may be connected to the upper computer 12 through a master device switch 18.

The upper computer 12 may be further configured to determine a deviation correction value of the system 10 according to the sizes of the plurality of tab regions determined from the plurality of second images shot by the plurality of second detection mechanisms 11-2, and send the deviation correction value to the deviation correction mechanism 17.

The deviation correction mechanism 17 is configured to perform deviation correction on the system 10 based on the deviation correction value.

In the embodiments of the present application, the deviation correction of the system 10 may include, after a deviation occurs, adjusting the position of the first electrode sheet to ensure that the width of the tab region cut in the width direction remains consistent when the cutting mechanism 16 cuts the first electrode sheet. The deviation correction mechanism 17 can adjust the position of the first electrode sheet, including adjusting its angle, position in the width direction and the like in the system, so that the cutter of the cutting mechanism 16 is aligned with the central axis of the cutting position.

Thus, the deviation correction of the electrode sheet roll-pressing and cutting system 10 can be realized, and the product quality of the electrode sheet roll-pressing and cutting system 10 can be improved.

In some embodiments, the upper computer 12 may determine the deviation correction value of the system 10 in the following manner:
determining a size difference between each pair of tab regions in the plurality of tab regions, where each pair of tab regions is two tab regions located on two sides of a same cutting position; and
determining the deviation correction value based on the size difference.

In some embodiments of the present application, the cutting mechanism 16 may cut the first electrode sheet at a plurality of cutting positions, so that multiple pairs of tab regions may be obtained. Based on this, when the deviation correction value is determined, the size difference of each pair of tab regions may be calculated respectively, and then the average value of the size differences of the multiple pairs of tab regions is used as the deviation correction value.

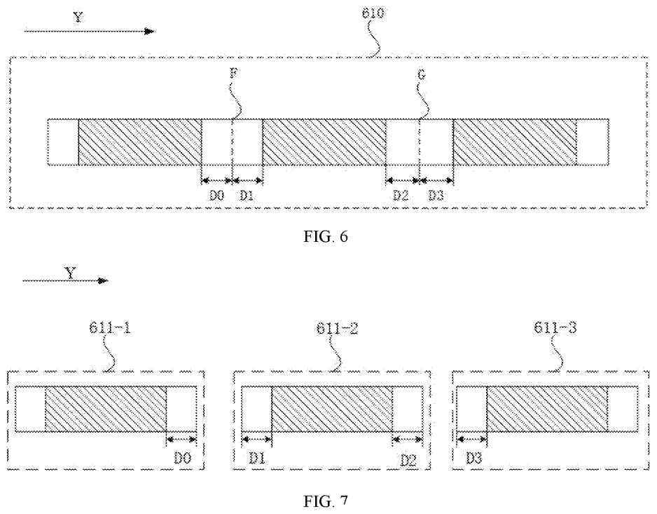

In some specific embodiments, the first electrode sheet 610 is the anode electrode sheet as shown in FIG. 6, where a shadow region is a coating region, a blank region is a tab region, and the first electrode sheet 610 includes two cutting positions F and G; when the cutting mechanism 16 cuts the first electrode sheet 610, cutting is performed at cutting positions F and G respectively, so as to obtain a first second electrode sheet 611-1, a second second electrode sheet 611-2 and a third second electrode sheet 611-3 as shown in FIG. 7, where the right tab region of the first second electrode sheet 611-1 and the left tab region of the second second electrode sheet 611-2 correspond to the same cutting position F, so these two tab regions can be used as a pair of tab regions, and the right tab region of the second second electrode sheet 611-2 and the left tab region of the third second electrode sheet 611-3 correspond to the same cutting position G, so these two tab regions can be used as a pair of tab regions. Based on this, the upper computer 12 may calculate a first size difference between the right tab region of the first second electrode sheet 611-1 and the left tab region of the second second electrode sheet 611-2, and a second size difference between the right tab region of the second second electrode sheet 611-2 and the left tab region of the third second electrode sheet 611-3, and an average value of the first size difference and the second size difference is used as the deviation correction value of the system 10.

The deviation correction value of the system 10 may be calculated according to the following formula (5):

$$F = \frac{\vert {D}_{1} - {D}_{2} \vert + \vert {D}_{3} - {D}_{4} \vert}{2} . \qquad ( 5 )$$

In formula (5), F represents a deviation correction value. D₁ represents a size of the right tab region of the second electrode sheet 611 arranged at a first position. D₂ represents a size of the left tab region of the second electrode sheet 611 arranged at a second position. D₃ represents a size of the right tab region of the second electrode sheet 611 arranged at the second position. D₄ represents a size of the left tab region of the second electrode sheet 611 arranged at a third position.

In the above manner, the deviation correction value that can represent the dimensional consistency of the tab region of the second electrode sheet can be obtained, so that when the deviation correction mechanism 17 corrects the electrode sheet roll-pressing and cutting system 10 based on the deviation correction value, the dimensional consistency of the plurality of tab regions obtained by cutting can be improved.

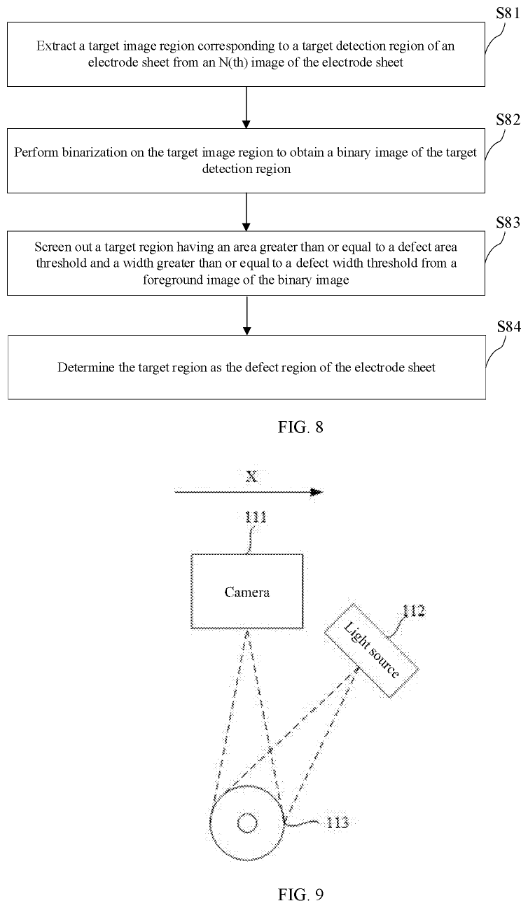

In some embodiments, referring to FIG. 8, the upper computer 12 may determine the defect region of the electrode sheet based on the N(th) image of the electrode sheet by using the following steps S81 to S84:

S81: extracting a target image region corresponding to a target detection region of the electrode sheet from the N(th) image of the electrode sheet.

In some embodiments of the present application, the surface of the electrode sheet usually includes a plurality of regions, for example, the surface of the anode electrode sheet usually includes a tab region and a coating region, the surface of the cathode electrode sheet usually includes the tab region, the coating region and the anti-tearing region, and the target detection region may be any region that is selected from regions of the electrode sheet and needs to be subjected to surface defect detection according to actual needs. For example, when the electrode sheet in the system 10 is the anode electrode sheet, the coating region in the electrode sheet may be used as the target detection region. When the electrode sheet in the system 10 is the cathode electrode sheet, the coating region and the anti-tearing region in the electrode sheet may be used as the target detection region.

Different regions in the electrode sheet correspond to different grayscale value ranges in the image. Based on this, the image may be segmented into a plurality of image regions according to the grayscale value ranges corresponding to the regions, one image region corresponds to one grayscale value range, and then an image region corresponding to a target grayscale value range corresponding to the target detection region in the plurality of image regions is used as the target image region.

In some embodiments of the present application, the N(th) image of the electrode sheet may be a grayscale image or a color image; when the image is the grayscale image, the target image region may be directly determined from the image; and when the image is the color image, the image may be converted into the grayscale image, and then the target image region may be determined from the converted image.

In some embodiments of the present application, the grayscale value range corresponding to each region in the electrode sheet may be preset based on actual needs before the detection mechanism 11 is used to shoot the image of the electrode sheet. To ensure that the gray value range of the image region corresponding to the electrode sheet in the image is consistent with the gray value range corresponding to the electrode sheet, the detection mechanism 11 may be adjusted based on the grayscale value range of each region before the detection mechanism 11 is used to shoot the image of the electrode sheet, so that the grayscale value range of the image region corresponding to each region in the image shot by the detection mechanism 11 is consistent with the set grayscale value range.

S82: performing binarization on the target image region to obtain a binary image of the target detection region.

In some embodiments of the present application, a binarization threshold may be set according to the target grayscale value range corresponding to the target image region, and the target image region is binarized according to the binarization threshold to obtain the binary image of the surface of the target detection region. The binarization threshold may include an upper limit value of the target grayscale value range and a lower limit value thereof, so that pixels falling within the target grayscale value range and pixels not falling within the target grayscale value range in the target image region may be distinguished through binarization, an image corresponding to the pixels falling within the target grayscale value range in the binary image is used as a background image, and an image corresponding to the pixels not falling within the target grayscale value range in the binary image is used as a foreground image. The foreground image is an image corresponding to the surface defect of the target detection region.

S83: screening out a target region having an area greater than or equal to a defect area threshold and a width greater than or equal to a defect width threshold from the foreground image of the binary image.

Considering that the influence of defects such as small sizes on the performance of the electrode sheet can be ignored, only the defect regions that have an influence on the performance of the electrode sheet can be detected when the defect regions are detected.

In some embodiments of the present application, the connected region may be marked on the foreground image in the binary image by Blob analysis, the area and width of each marked connected region are calculated, the area of each connected region is compared with a preset defect region threshold, if the area of the connected region is greater than or equal to the defect area threshold, the width of the connected region is further compared with a preset defect width threshold, and if the width of the connected region is greater than or equal to the defect width threshold, the connected region is marked as the target region.

S84: determining the target region as the defect region of the electrode sheet.

Thus, the defect region that is located in the target detection region and affects the performance of the electrode sheet can be accurately detected.

In some embodiments, referring to FIG. 9, the detection mechanism 11 may include a camera 111, a light source 112, and a detection roller 113, and as shown in FIG. 9, the camera 111 and the light source 112 in the detection mechanism 11 are both disposed toward the detection roller 113. The detection roller 113 is configured to support the electrode sheet, so that the first surface or the second surface that needs to be shot in the electrode sheet faces the camera 111, and the light source 112 is configured to illuminate the surface of the electrode sheet facing the camera 111.

The first detection mechanism 11-1 is taken as an example; referring to FIG. 11, the first detection mechanism 11-1 may include a first camera 111-1, a first light source 112-1, and a first detection roller 113-1. The first camera 111-1 is disposed toward the first detection roller 113-1. The first detection roller 113-1 is configured to support the first electrode sheet so that a first surface of the first electrode sheet faces the first camera 111-1; the first light source 112-1 is configured to illuminate the first surface of the first electrode sheet; and the first camera 111-1 is configured to shoot the first surface of the illuminated first electrode sheet.

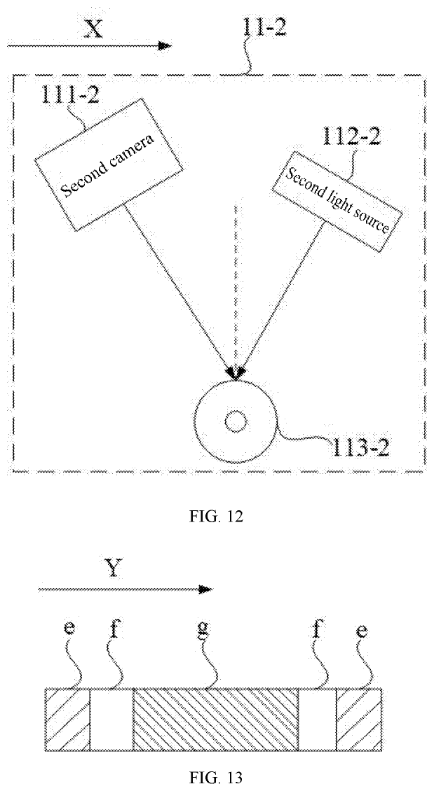

The second detection mechanism 11-2 is taken as an example; referring to FIG. 12, the second detection mechanism 11-2 may include a second camera 111-2, a second light source 112-2, and a second detection roller 113-2, and the second camera 111-2 in the second detection mechanism 11-2 is disposed toward the second detection roller 113-2. The second detection roller 113-2 is configured to support the second electrode sheet, so that the second surface of the second electrode sheet faces the second camera 111-2 in the second detection mechanism 11-2. The second light source 112-2 is configured to illuminate the second surface of the second electrode sheet. The second camera 111-2 is configured to shoot the second surface of the illuminated second electrode sheet.

Thus, with the provision of the light source 112 and the detection roller 113, the detection mechanism 11 can more conveniently shoot the surface of the electrode sheet, and the defects on the surface of the electrode sheet can be made more prominent in the image.

In some embodiments, in order to improve the roll-pressing and cutting efficiency of the electrode sheet, enable the system 10 to cut the wide electrode sheet, and perform online detection on the defects and sizes of the wide electrode sheet, a plurality of cameras 111 and a plurality of light sources 112 disposed corresponding to the plurality of cameras 111 may be disposed in each detection mechanism 11, the plurality of cameras 111 and the plurality of light sources 112 are both disposed toward the detection roller 113, and the plurality of cameras 111 may be arranged side by side in the width direction of the electrode sheet. In the same detection mechanism 11, the plurality of cameras 111 synchronously shoot the same surface of the electrode sheet on the detection roller 113, and since the plurality of cameras 111 are disposed at different positions, the shot electrode sheet regions are different, in this case, the plurality of images synchronously collected by the plurality of cameras 111 may be spliced, the overlapping region in the spliced image is removed to obtain the complete image of the electrode sheet, and the upper computer 12 may detect the defect region of the electrode sheet based on the spliced complete image.

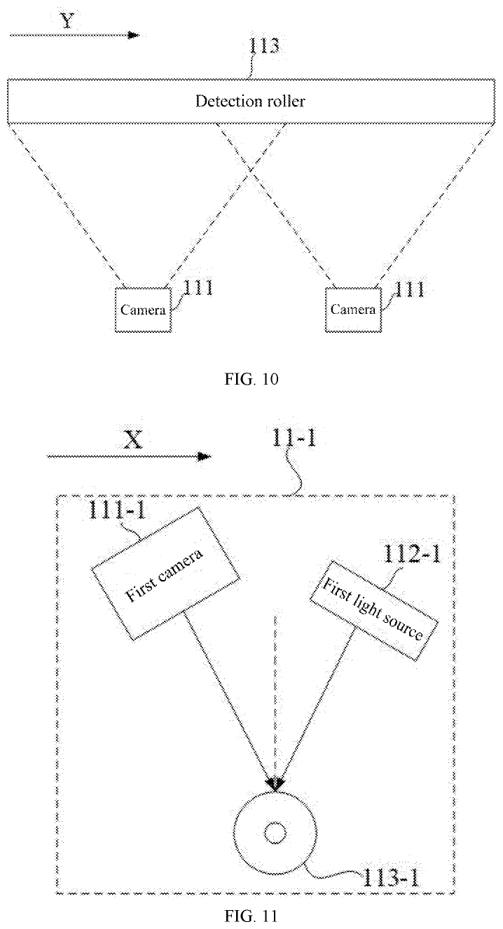

In some embodiments, one detection mechanism 11 may include two cameras 111, and as shown in FIG. 10, the two cameras 111 may be arranged side by side in the second direction Y.

Thus, the system 10 can implement defect detection and tab region size detection on the wide electrode sheet.

In some embodiments, the camera 111 may be a line scan camera, so that image of the electrode sheet moving at a high speed can be shot.

In some embodiments, the electrode sheet usually includes a plurality of regions, so the image of the electrode sheet includes image regions corresponding to the plurality of regions; when the electrode sheet is supported by the detection roller 113, the image may further include an image region corresponding to the detection roller 113, and in view of this, in order to facilitate distinguishing the image regions corresponding to the regions in the electrode sheet and the detection roller 113 in the image, the irradiation angle of the light source 112 and the shooting angle and shooting point of the camera 111 in the detection mechanism 11 may be set according to the set grayscale value ranges corresponding to the regions.

In addition, a working distance of the camera 111 may also be set according to the focal length of the lens in the camera 111. The working distance of the camera 111 refers to a distance between the camera 111 and the detection roller 113. Generally, the smaller the focal length of the lens, the shorter the working distance of the camera. For example, the camera 111 is a 16K line scan camera, the pixel size thereof is 3.5 μm, the chip target surface size is 57.3 mm, and the camera field of view is 900 mm when a lens with a focal length of 40 mm is used, so that the working distance of the camera 111 can be set to 650 mm.

In some specific embodiments, if the electrode sheet in the system 10 is the anode electrode sheet, the current collector of the anode electrode sheet is copper foil, and the material of the anode electrode sheet is carbon powder; when the grayscale value range corresponding to the detection roller 113 is set to 0-10, the grayscale value range corresponding to the tab region is set to 255, and the grayscale value range corresponding to the coating region is set to 40-60; after the shooting angle of the camera 111, the irradiation angle of the light source 112, and the shooting point are set based on the above grayscale value ranges, the anode electrode sheet in the system 10 is shot by the camera 111, and an image as shown in FIG. 13 can be obtained, where e in FIG. 11 represents an image region corresponding to the detection roller 113, f represents an image region corresponding to the tab region in the anode electrode sheet, and g represents an image region corresponding to the coating region in the anode electrode sheet.

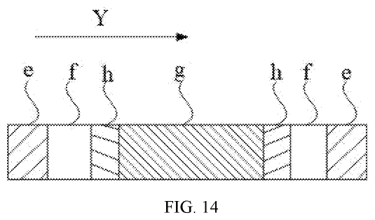

In some embodiments of the present application, if the electrode sheet in the system 10 is the cathode electrode sheet, the material of the cathode electrode sheet is aluminum foil, and there are anti-tearing regions on both sides of the coating region; when the grayscale value range corresponding to the detection roller 113 is set to 0-10, the grayscale value range corresponding to the tab region is set to 255, and the grayscale value range corresponding to the coating region is set to 20-40; when the grayscale value range corresponding to the anti-tearing region is set to 110-130, after the shooting angle of the camera 111, the irradiation angle of the light source 112, and the shooting point are set based on the above grayscale value ranges, the cathode electrode sheet in the system 10 is shot by the camera 111, and an image as shown in FIG. 14 can be obtained. In FIG. 14, e represents an image region corresponding to the detection roller 113, f represents an image region corresponding to the tab region in the cathode electrode sheet, h represents an image region corresponding to the anti-tearing region in the cathode electrode sheet, and g represents an image region corresponding to the coating region in the cathode electrode sheet.

Thus, the grayscale value ranges corresponding to different regions in the detection image may be different, which facilitates distinguishing the image regions corresponding to different regions.

Based on the electrode sheet roll-pressing and cutting system provided in the foregoing embodiments, an embodiment of the present application further provides a specific implementation of an electrode sheet roll-pressing and cutting method. Refer to the following embodiments.

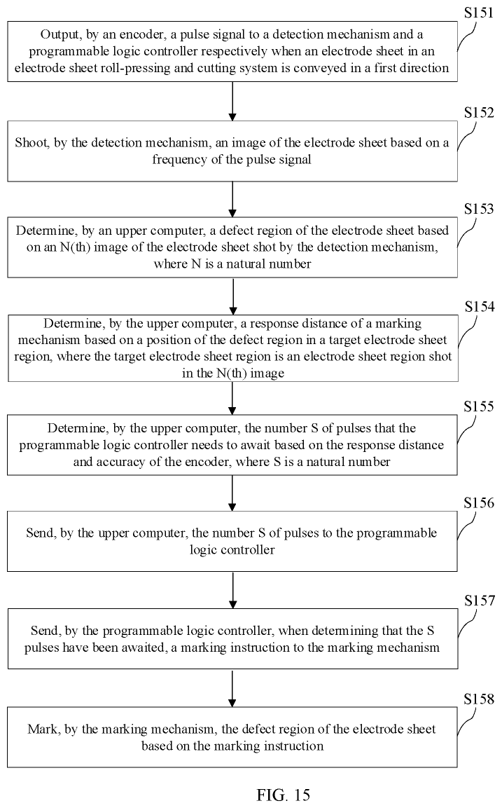

FIG. 15 is a flowchart of an electrode sheet roll-pressing and cutting method according to an embodiment of the present application; as shown in FIG. 15, the method may include the following steps S151 to S158:
S151: outputting, by an encoder, a pulse signal to a detection mechanism and a programmable logic controller respectively when an electrode sheet in an electrode sheet roll-pressing and cutting system is conveyed in a first direction;
S152: shooting, by the detection mechanism, an image of the electrode sheet based on a frequency of the pulse signal;
S153: determining, by an upper computer, a defect region of the electrode sheet based on an N(th) image of the electrode sheet shot by the detection mechanism, where N is a natural number;
S154: determining, by the upper computer, a response distance of a marking mechanism based on a position of the defect region in a target electrode sheet region, where the target electrode sheet region is an electrode sheet region shot in the N(th) image;
S155: determining, by the upper computer, the number S of pulses that the programmable logic controller needs to await based on the response distance and accuracy of the encoder, where S is a natural number;
S156: sending the number S of pulses to the programmable logic controller by the upper computer;
S157: sending, by the programmable logic controller, when determining that the S pulses have been awaited, a marking instruction to the marking mechanism; and
S158: marking, by the marking mechanism, the defect region of the electrode sheet based on the marking instruction.

In the above manner, the present application can determine the defect region in the electrode sheet, and accurately mark the defect region based on the position of the defect region in the electrode sheet.

In some embodiments, the marking mechanism is located downstream of the detection mechanism, a first distance between the detection mechanism and the marking mechanism is a sum of the sizes of (M+1) images and a redundant distance, and the size of a single image is a length of an electrode sheet region shot in the image in the first direction, where M is a natural number;
the determining, by the upper computer, a response distance of a marking mechanism based on a position of the defect region in a target electrode sheet region includes:
determining, by the upper computer, a second distance between the defect region and a second edge of the target electrode sheet region, the second edge being an edge of the target electrode sheet region in an electrode sheet transmission direction; and
determining a sum of the second distance and the redundant distance as a response distance of the marking mechanism; and
correspondingly, the sending the number S of pulses to the programmable logic controller by the upper computer includes:
sending, by the upper computer, when determining that the detection mechanism has shot the (N+M)th image of the electrode sheet, the number S of pulses to the programmable logic controller.

Thus, the marking mechanism can be accurately controlled to mark the defect position of the electrode sheet.

Further, the image shot by the detection mechanism including a tab region image corresponding to a tab region; and based on this, the electrode sheet roll-pressing and cutting method further includes:
by the upper computer, identifying edges of the tab region image and determining the size of the tab region based on the edges.

In addition, the size information of the tab region in the electrode sheet can also be obtained through the upper computer.

In some embodiments, the electrode sheet in the electrode sheet roll-pressing and cutting system includes a first electrode sheet input into the system and a plurality of second electrode sheets obtained by cutting the first electrode sheet by a cutting mechanism, the detection mechanism comprises a first detection mechanism and a plurality of second detection mechanisms, and the plurality of second detection mechanisms are in one-to-one correspondence with the plurality of second electrode sheets; and the shooting, by the detection mechanism, an image of the electrode sheet based on a frequency of the pulse signal includes:
shooting, by the first detection mechanism, a first surface of the first electrode sheet based on the frequency of the pulse signal to obtain a first image; and
shooting, by the plurality of second detection mechanisms, second surfaces of the plurality of second electrode sheets based on the frequency of the pulse signal to obtain a plurality of second images.

Correspondingly, the determining, by an upper computer, a defect region of the electrode sheet based on the N(th) image of the electrode sheet shot by the detection mechanism may include:
determining, by the upper computer, the defect region of the first surface based on the N(th) first image shot by the first detection mechanism, and/or determining, by the upper computer, the defect region of the second surface based on the N(th) second image shot by the second detection mechanism.

In addition, the step of, by the upper computer, identifying edges of the tab region image and determining the size of the tab region based on the edges may include:
determining, by the upper computer, the size of the tab region in the first electrode sheet based on the first image shot by the first detection mechanism, and/or determining, by the upper computer, the size of the tab region in the second electrode sheet based on the second image shot by the second detection mechanism.

Thus, with the provision of the first detection mechanism and the plurality of second detection mechanisms, defects on the first surface and second surface of each electrode sheet in the electrode sheet roll-pressing and cutting system can be detected and the size of the tab region of each electrode sheet can be determined.

In some embodiments, the determining the size of the tab region based on the edges may include:
generating first edge points at the edges;
removing discrete edge points from the first edge points to obtain second edge points;
performing straight line fitting on the second edge points to obtain two edge lines in a second direction, the second direction being perpendicular to the first direction; and
determining a distance between the two edge lines as the size of the tab region.

Thus, the size of the tab region in the second direction can be obtained.

In some embodiments, the electrode sheet roll-pressing and cutting method may further include:
determining, by the upper computer, a deviation correction value for electrode sheet roll-pressing and cutting according to the sizes of the plurality of tab regions determined from the plurality of second images; and sending, by the upper computer, the deviation correction value to the deviation correction mechanism;
performing, by the deviation correction mechanism, deviation correction on the electrode sheet roll-pressing and cutting based on the deviation correction value.

Thus, the deviation correction of the electrode sheet roll-pressing and cutting system can be realized, and the product quality of the electrode sheet roll-pressing and cutting system can be improved.

In some embodiments, the determining, by the upper computer, a deviation correction value for electrode sheet roll-pressing and cutting according to the sizes of the plurality of tab regions identified from the plurality of second images includes:
determining, by the upper computer, a size difference between each pair of tab regions in the plurality of tab regions, where each pair of tab regions is two tab regions located on two sides of a same cutting position; and
determining the deviation correction value based on the size difference.

Thus, the deviation correction value that can represent the dimensional consistency of the tab region of the second electrode sheet can be obtained.

In some embodiments, the determining, by an upper computer, a defect region of the electrode sheet based on an N(th) image of the electrode sheet shot by the detection mechanism may include:
extracting, by the upper computer, a target image region corresponding to a target detection region of the electrode sheet from the N(th) image of the electrode sheet;
performing binarization on the target image region to obtain a binary image of the target detection region;
screening out a target region having an area greater than or equal to an area threshold and a width greater than or equal to a width threshold from a foreground image of the binary image; and
determining the target region as the defect region of the electrode sheet.

In some embodiments, the shooting, by the first detection mechanism, a first surface of the first electrode sheet based on the frequency of the pulse signal to obtain a first image includes:
supporting, the first electrode sheet by the first detection roller, so that a first surface of the first electrode sheet faces the first camera;
illuminating the first surface by the first light source; and
shooting, by the first camera, the illuminated first surface based on the frequency of the pulse signal to obtain the first image.

Thus, the defects on the first surface of the first electrode sheet can be made more prominent in the first image.

In some embodiments, the shooting, by the second detection mechanism, a second surface of the second electrode sheet based on the frequency of the pulse signal to obtain a second image includes:
supporting the second electrode sheet by the second detection roller, so that the second surface of the second electrode sheet faces the second camera;
illuminating the second surface by the second light source; and
shooting, by the second camera, the illuminated second surface based on the frequency of the pulse signal to obtain the second image.

Thus, the defects on the second surface of the second electrode sheet can be made more prominent in the second image.

Although the present application has been described with reference to some preferred embodiments, various modifications to the present application and replacements of the components therein with equivalents can be made without departing from the scope of the present application. In particular, the technical features mentioned in the embodiments may be combined in any manner provided that there is no structural conflict. The present application is not limited to the specific embodiments disclosed herein, but includes all technical solutions falling within the scope of the claims.

What is claimed is:

1. An electrode sheet roll-pressing and cutting system, comprising:
an encoder, configured to output a pulse signal to a detection mechanism and a programmable logic controller respectively when an electrode sheet in the system is conveyed in a first direction;
the detection mechanism, configured to shoot an image of the electrode sheet in the electrode sheet roll-pressing and cutting system based on a frequency of the pulse signal;
an upper computer, configured to determine a defect region of the electrode sheet based on an N(th) image of the electrode sheet shot by the detection mechanism, wherein N is a natural number; and
further configured to: determine a response distance of a marking mechanism based on a position of the defect region in a target electrode sheet region, wherein the target electrode sheet region is an electrode sheet region shot in the N(th) image; determine the number S of pulses that the programmable logic controller needs to await based on the response distance and accuracy of the encoder; and send the number S of pulses to the programmable logic controller, wherein S is a natural number;
the programmable logic controller, when determining that the S pulses have been awaited, configured to send a marking instruction to the marking mechanism;
the marking mechanism, configured to mark the defect region of the electrode sheet based on the marking instruction; and
the image shot by the detection mechanism comprising a tab region image corresponding to a tab region; and
the upper computer, being further configured to identify edges of the tab region image and determine the size of the tab region based on the edges.

2. The system according to claim 1, wherein the marking mechanism is located downstream of the detection mechanism, a first distance between the detection mechanism and the marking mechanism is a sum of the sizes of (M+1) images and a redundant distance, and the size of a single image is a length of an electrode sheet region shot in the image in the first direction, wherein M is a natural number;
the upper computer is configured to determine a second distance between the defect region and a second edge of the target electrode sheet region, the target electrode sheet region comprising a first edge and the second edge, and a direction from the first edge to the second edge being the first direction; and determine a sum of the second distance and the redundant distance as a response distance of the marking mechanism; and
when determining that the detection mechanism has shot the (N+M)th image of the electrode sheet, the upper computer is further configured to send the number S of pulses to the programmable logic controller.

3. The system according to claim 1, further comprising a cutting mechanism, wherein
the cutting mechanism is configured to cut a first electrode sheet input into the system into a plurality of second electrode sheets, wherein a width of the first electrode sheet is greater than a width of the second electrode sheet;
the detection mechanism comprises a first detection mechanism disposed upstream of the cutting mechanism and a plurality of second detection mechanisms disposed downstream of the cutting mechanism, and the plurality of second detection mechanisms are in one-to-one correspondence with the plurality of second electrode sheets;
the first detection mechanism is configured to shoot a first surface of the first electrode sheet based on the frequency of the pulse signal to obtain a first image;
the plurality of second detection mechanisms are configured to shoot second surfaces of the plurality of second electrode sheets based on the frequency of the pulse signal to obtain a plurality of second images; and
the upper computer is configured to determine the sizes of the defect region and the tab region of the first electrode sheet and/or the plurality of second electrode sheets based on the first image and/or the plurality of second images.

4. The system according to claim 1, wherein the upper computer is configured to: generate first edge points at the edges; remove discrete edge points from the first edge points to obtain second edge points; perform straight line fitting on the second edge points to obtain two edge lines in a second direction, the second direction being perpendicular to the first direction; and determine a distance between the two edge lines as the size of the tab region.

5. The system according to claim 3, further comprising a deviation correction mechanism, wherein
the upper computer is further configured to determine a deviation correction value for electrode sheet roll-pressing and cutting according to the sizes of the plurality of tab regions determined from the plurality of second images, and send the deviation correction value to the deviation correction mechanism; and
the deviation correction mechanism is configured to perform deviation correction on the electrode sheet roll-pressing and cutting based on the deviation correction value.

6. The system according to claim 5, wherein the upper computer is configured to determine a size difference between each pair of tab regions in the plurality of tab regions, and each pair of tab regions is two tab regions located on two sides of a same cutting position; and determine the deviation correction value based on the size difference.

7. The system according to claim 1, wherein the upper computer is configured to extract a target image region corresponding to a target detection region of the electrode sheet from the N(th) image of the electrode sheet; perform binarization on the target image region to obtain a binary image of the target detection region; screen out a target region having an area greater than or equal to an area threshold and a width greater than or equal to a width threshold from a foreground image of the binary image; and determine the target region as the defect region of the electrode sheet.

8. The system according to claim 3, wherein the first detection mechanism further comprises a first camera, a first light source, and a first detection roller;
the first camera is disposed toward the first detection roller;
the first detection roller is configured to support the first electrode sheet, so that a first surface of the first electrode sheet faces the first camera;
the first light source is configured to illuminate the first surface; and
the first camera is configured to shoot the illuminated first surface based on the frequency of the pulse signal to obtain the first image.

9. The system according to claim 5, wherein the first detection mechanism further comprises a first camera, a first light source, and a first detection roller;
the first camera is disposed toward the first detection roller;
the first detection roller is configured to support the first electrode sheet, so that a first surface of the first electrode sheet faces the first camera;
the first light source is configured to illuminate the first surface; and
the first camera is configured to shoot the illuminated first surface based on the frequency of the pulse signal to obtain the first image.

10. The system according to claim 6, wherein the first detection mechanism further comprises a first camera, a first light source, and a first detection roller;
the first camera is disposed toward the first detection roller;
the first detection roller is configured to support the first electrode sheet, so that a first surface of the first electrode sheet faces the first camera;
the first light source is configured to illuminate the first surface; and
the first camera is configured to shoot the illuminated first surface based on the frequency of the pulse signal to obtain the first image.

11. The system according to claim 3, wherein the second detection mechanism comprises a second camera, a second light source, and a second detection roller;
the second camera is disposed toward the second detection roller;
the second detection roller is configured to support the second electrode sheet, so that a second surface of the second electrode sheet faces the second camera;
the second light source is configured to illuminate the second surface; and
the second camera is configured to shoot the illuminated second surface based on the frequency of the pulse signal to obtain the second image.

12. The system according to claim 5, wherein the second detection mechanism comprises a second camera, a second light source, and a second detection roller;
the second camera is disposed toward the second detection roller;
the second detection roller is configured to support the second electrode sheet, so that a second surface of the second electrode sheet faces the second camera;
the second light source is configured to illuminate the second surface; and
the second camera is configured to shoot the illuminated second surface based on the frequency of the pulse signal to obtain the second image.

13. The system according to claim 6, wherein the second detection mechanism comprises a second camera, a second light source, and a second detection roller;
the second camera is disposed toward the second detection roller;
the second detection roller is configured to support the second electrode sheet, so that a second surface of the second electrode sheet faces the second camera;
the second light source is configured to illuminate the second surface; and
the second camera is configured to shoot the illuminated second surface based on the frequency of the pulse signal to obtain the second image.

14. An electrode sheet roll-pressing and cutting method, comprising:
outputting, by an encoder, a pulse signal to a detection mechanism and a programmable logic controller respectively when an electrode sheet in an electrode sheet roll-pressing and cutting system is conveyed in a first direction;
shooting, by the detection mechanism, an image of the electrode sheet based on a frequency of the pulse signal;
determining, by an upper computer, a defect region of the electrode sheet based on an N(th) image of the electrode sheet shot by the detection mechanism, wherein Nis a natural number;
determining, by the upper computer, a response distance of a marking mechanism based on a position of the defect region in a target electrode sheet region, wherein the target electrode sheet region is an electrode sheet region shot in the N(th) image;
determining, by the upper computer, the number S of pulses that the programmable logic controller needs to await based on the response distance and accuracy of the encoder, wherein S is a natural number;
sending, by the upper computer, the number S of pulses to the programmable logic controller;
sending, by the programmable logic controller, when determining that the S pulses have been awaited, a marking instruction to the marking mechanism; and
marking, by the marking mechanism, the defect region of the electrode sheet based on the marking instruction;
the image shot by the detection mechanism comprising a tab region image corresponding to a tab region; and the electrode sheet roll-pressing and cutting method further comprises:
by the upper computer, identifying edges of the tab region image and determining the size of the tab region based on the edges.

15. The method according to claim 14, wherein the marking mechanism is located downstream of the detection mechanism, a first distance between the detection mechanism and the marking mechanism is a sum of the sizes of (M+1) images and a redundant distance, and the size of a single image is a length of an electrode sheet region shot in the image in the first direction, wherein M is a natural number;
the determining, by the upper computer, a response distance of a marking mechanism based on a position of the defect region in a target electrode sheet region comprises:
determining, by the upper computer, a second distance between the defect region and a target edge of the target electrode sheet region, the target edge being an edge of the target electrode sheet region in an electrode sheet transmission direction; and
determining a sum of the second distance and the redundant distance as a response distance of the marking mechanism; and
the sending the number S of pulses to the programmable logic controller by the upper computer comprises:
sending, by the upper computer, when determining that the detection mechanism has shot the (N+M)th image of the electrode sheet, the number S of pulses to the programmable logic controller.

16. The method according to claim 14, wherein the electrode sheet in the electrode sheet roll-pressing and cutting system comprise a first electrode sheet input into the system and a plurality of second electrode sheets obtained by cutting the first electrode sheet by a cutting mechanism, the detection mechanism comprises a first detection mechanism and a plurality of second detection mechanisms, and the plurality of second detection mechanisms are in one-to-one correspondence with the plurality of second electrode sheets; and the shooting, by the detection mechanism, an image of the electrode sheet based on a frequency of the pulse signal comprises:
shooting, by the first detection mechanism, a first surface of the first electrode sheet based on the frequency of the pulse signal to obtain a first image; and
shooting, by the plurality of second detection mechanisms, second surfaces of the plurality of second electrode sheets based on the frequency of the pulse signal to obtain a plurality of second images.
